(19) United States
(12) Patent Application Publication
(10) Pub. No.: US 2004/0003794 A1
(43) Pub. Date: Jan. 8, 2004

(54) Fuel-injection device

(76) Inventors: Bernd Mahr, Plochingen (DE); Martin Kropp, Tamm (DE); Hans-Christoph Magel, Pfullingen (DE); Wolfgang Otterbach, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/221,314

(22) PCT Filed: Dec. 19, 2001
(86) PCT No.: PCT/DE01/04798

(30) Foreign Application Priority Data
Jan. 13, 2001 (DE) 101-01-358.2

(51) Int. Cl. F02M 1/00

(52) U.S. Cl. 123/447

(57) ABSTRACT

A pressure-controlled fuel injection system (1) has a common pressure reservoir, one injector (3) per cylinder, and one local pressure booster (4) assigned to each injector (3). A 2/2-way valve (14) is provided for metering fuel to the injector (3).

### PRIOR ART

The invention relates to a fuel injection system as generically defined by the preamble to claim 1.

For the sake of better understanding of the description and claims, some terms will now be defined: The fuel injection system of the invention is embodied as pressure-controlled. Within the context of the invention, a pressure-controlled fuel injection system is understood to mean that by means of the fuel pressure prevailing in the nozzle chamber of an injector, a nozzle needle is moved counter to the action of a closing force (spring), so that the injection opening is opened for an injection of the fuel from the nozzle chamber into the cylinder. The pressure at which fuel emerges from the nozzle chamber into a cylinder of an internal combustion engine is called the injection pressure, while the term system pressure is understood to mean the pressure at which fuel is available or kept on hand within the fuel injection system. Fuel metering means furnishing a defined quantity of fuel for injection. The term leakage is understood to mean a quantity of fuel that occurs in operation of the fuel injection system (for instance, a reference leakage or control quantity) that is not used for injection and is pumped back into the tank. The pressure level of this leakage can have a static pressure, after which the fuel is depressurized to the pressure level of the fuel tank.

In common rail systems, the injection pressure can be adapted to the load and rpm. For reducing noise, a preinjection is then often performed.

For reducing emissions, a pressure-controlled injection is known to be favorable. In the known pressure-controlled common rail systems, however, one 3/2-way valve, which is complicated to make, per injector is used, or two 2/2-way valves are used.

To increase the injection pressure, a pressure booster is possible, of the kind known for instance from U.S. Pat. No. 5,143,291 or U.S. Pat. No. 5,522,545. The disadvantage of these pressure-boosted systems is the lack of flexibility of the injection, and its low tolerance in terms of quantity when small fuel quantities are metered.

### ADVANTAGES OF THE INVENTION

For reducing costs in producing a fuel system, particularly for small engines, a fuel injection system in accordance with claim 1 is proposed. Using a single 2/2-way valve, as a metering valve, per cylinder in combination with a pressure booster makes for a less expensive system. In a refinement of the invention, this results in a common rail injection system that achieves the triggering of both the pressure booster and the injector with two 2/2-way valves. Both injection concepts allow a very high maximum injection pressure, a preinjection at a lower pressure level, and the achievement of a boot injection in the main injection.

### DRAWING

Three exemplary embodiments of the fuel injection system of the invention are shown in the schematic drawing and will be described in the ensuing description. Shown are:

FIG. 1, a first pressure-controlled fuel injection system with a pressure booster;

FIG. 2, a second pressure-controlled fuel injection system with a pressure booster;

FIG. 3, a third pressure-controlled fuel injection system with a pressure booster.

### DESCRIPTION OF THE EXEMPLARY EMBODIMENTS

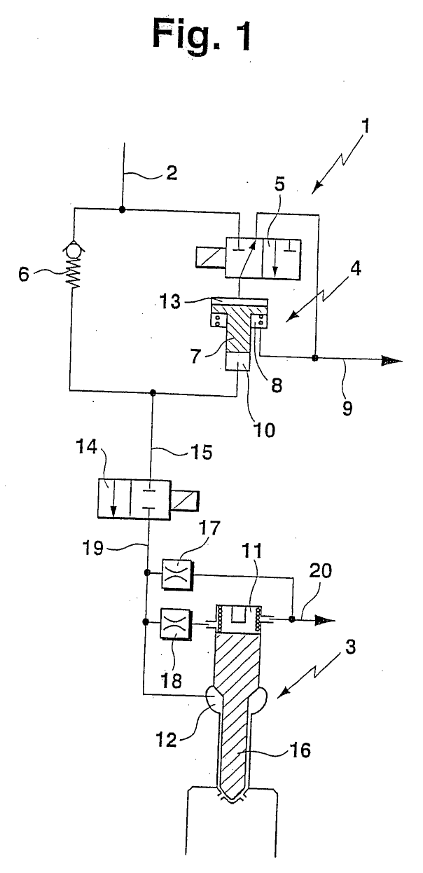

In the first exemplary embodiment, shown in FIG. 1, of a pressure-controlled fuel injection system 1, a fuel pump pumps fuel from a tank via a supply line into a central pressure reservoir (common rail), not shown in the drawings, from which a plurality of pressure lines 2, corresponding in number to the number of individual cylinders, lead to the individual injectors 3 that protrude into the combustion chamber of the engine to be supplied. In FIG. 1, only one of the injectors 3 is shown. With the aid of the fuel pump, a first system pressure is generated and stored in the pressure reservoir. This first system pressure is used for preinjection and, as needed, for postinjection (HC enrichment for exhaust gas posttreatment or soot reduction), and for providing an injection course with a plateau (boot injection). For injecting fuel at a second, higher system pressure, each injector 3 is assigned a respective local pressure booster 4. The pressure booster 4 cooperates with a 3/2-way valve 5 for triggering the pressure boost, a check valve 6, and a pressure means 7 in the form of a displaceable piston. The pressure means 7 can be connected on one end, with the aid of the valve 5, to the pressure line 2, so that the pressure means 7 can be subjected to pressure on one end. A differential chamber 8 is pressure-relieved by means of a leak fuel line 9, so that the pressure means 7 can be displaced to reduce the volume of a pressure chamber 10. The pressure means 7 is moved in the compression direction, so that the fuel located in the pressure chamber 10 is compressed and delivered to a control chamber 11 and a nozzle chamber 12. The check valve 6 prevents the return flow of compressed fuel to the pressure reservoir. By means of a suitable area ratio in a primary chamber 13 and the pressure chamber 10, a second, higher pressure can be generated. If the primary chamber 13 is connected with the aid of the valve 5 to the leak fuel line 9, the restoration of the pressure means 7 and refilling of the pressure chamber 10 take place. Because of the pressure ratios in the pressure chamber 10 and the primary chamber 13, the check valve 6 opens, so that the pressure chamber 10 is at rail pressure (the pressure of the pressure reservoir), and the pressure means 7 is returned hydraulically to its outset position. To improve the restoration behavior, one or more strings may be disposed in the chambers 8, 10 or 13. By means of the pressure boost, a second system pressure can thus be generated.

As metering valves, 2/2-way valves 14 are used, which are embodied as directly actuated force-balanced magnet valves. However, it can also be a piezoelectric actuator with a corresponding coupler chamber. With the aid of the metering valve 14, the injection is achieved in pressure-controlled fashion for each cylinder. With the aid of the valve 14, a pressure line 15 is made to communicate with the nozzle chamber 12. The injection is effected with the aid of a piston-like nozzle needle 16, which is axially displaceable in a guide bore and has a conical valve sealing face on one end, with which face it cooperates with a valve seat face on the injector housing. Injection openings are provided at the valve seat face of the housing. Inside the nozzle chamber 12, a pressure face pointing in the opening direction of the nozzle needle 16 is exposed to the pressure prevailing there, which pressure is supplied to the nozzle chamber 12 via the pressure line 15.

The injector 3 has a first pressure relief throttle 17 and a second pressure relief throttle 18. Via the pressure relief throttle 18, the pressure line 19 has a permanent open communication with the leak fuel line 20. Via the pressure relief throttle 18 and the control chamber 11, the pressure line 19 communicates with the leak fuel line 20 only when the injection opening is closed. Therefore besides a pressure relief throttle 17 that is always open, the injector has the further pressure relief throttle 18, which is closable by a stroke of nozzle needle 16. The smaller pressure relief throttle 17 leads to less leakage during the injection. Upon termination of the injection, the pressure in the nozzle chamber 12 initially drops only via the pressure relief throttle 17, and the nozzle needle 16 begins its closing operation. As a result, the still-closed pressure relief throttle 18 is opened, so that the closing operation of the nozzle needle 16 is sharply accelerated.

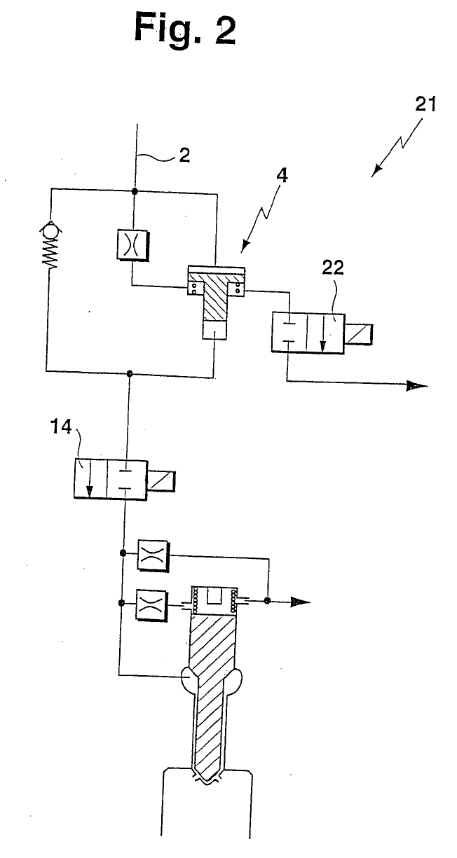

For controlling the pressure booster 4, FIG. 2 shows a further embodiment (fuel injection system 21), in which additionally, a 2/2-way valve 22 is also used to control the pressure booster 4. In the unswitched state, the valve 22 has no flow through it. The rail pressure from the pressure reservoir is present for metering at the valve 14. The pressure booster 4 has returned to its outset position. If the valve 22 is switched for a flow, then the pressure booster 4 brings about an increase in the rail pressure. This increased pressure is now available at the metering valve 14.

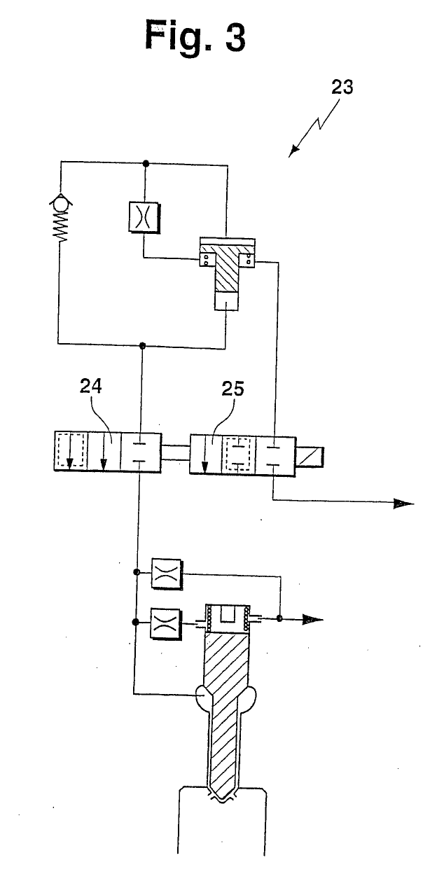

Both 2/2-way valves can be switched with one actuator, as shown in FIG. 3 (fuel injection system 23). The actuator (magnetic actuator or piezoelectric actuator) communicates with both valves and is embodied in three stages; that is, it has one position of repose and two switching positions. The two switching positions are triggered by different control voltages. In the position of repose, both of the valves have no flow. In the first switching position, only the valve 24 is switched for a flow and thus only then is an injection at rail pressure generated. In the second switching position, the valve 24 and the valve 25 are switched for flow, and an injection takes place at the pressure increased by the pressure booster 4. If the first switching position is achieved first, and the second switching position is embodied after a certain delay during the injection, then a boot injection takes place.

1. A pressure-controlled fuel injection system (1; 21; 23) having a common pressure reservoir, having one injector (3) per cylinder, and having one local pressure booster (4) assigned to each injector (3), characterized in that a 2/2-way valve (14; 24) is provided for metering fuel to the injector (3).

2. The fuel injection system of claim 1, characterized in that a 2/2-way valve (22) is provided for triggering the pressure booster (4).

3. The fuel injection system of claim 1 or 2, characterized in that the actuation of both control valves by one common actuator is provided.
